(19) United States
(12) Patent Application Publication
(10) Pub. No.: US 2025/0084950 A1
(43) Pub. Date: Mar. 13, 2025

(54) DEVICE FOR THE TEMPERATURE CONTROL OF FLUIDS

(71) Applicant: BASF SE, Ludwigshafen am Rhein (DE)

(72) Inventor: Claus HECHLER, Ludwigshafen am Rhein (DE)

(21) Appl. No.: 18/281,799

(22) PCT Filed: Mar. 10, 2022
(86) PCT No.: PCT/EP2022/056154

§ 371 Date: Sep. 13, 2023

(30) Foreign Application Priority Data
Mar. 15, 2021 (EP) 21162653.6

(51) Int. Cl. F16L 59/02; F16L 53/38; F16L 53/70

(52) U.S. Cl. CPC F16L 59/029; F16L 53/38; F16L 53/70

(57) ABSTRACT

The invention relates to an apparatus for controlling the temperature of fluids, comprising a wall (3), a first insulation layer (9), means of temperature control (13), and a second insulation layer (11), where the wall (3) is in contact on one side with the fluid of which the temperature is to be controlled and the first insulation layer (9) has been applied to the side of the wall (3) facing away from the fluid, and the means of temperature control (13) are disposed between the first insulation layer (9) and the second insulation layer (11). The invention further relates to a method of controlling the temperature of a fluid in a pipeline (1), a duct of any cross section or a vessel with an apparatus (7), wherein the means of temperature control (13) are actuated such that a heating output is applied only when the ambient temperature (115) is lower than a minimum permissible temperature of the fluid and/or a cooling output is applied only when the ambient temperature (115) is higher than the maximum permissible temperature of the fluid.

The invention relates to an apparatus for controlling the temperature of fluids, especially for controlling the temperature of fluids in a pipeline, a duct of any cross section or a vessel. The invention further relates to a method of controlling the temperature of fluids using the apparatus.

At present, temperature control is typically accomplished using temperature control conduits through which a temperature control medium flows, these being juxtaposed, for example, with the pipelines or ducts that conduct the medium, or, especially in order to prevent losses of heat to the environment, which can lead to unwanted or impermissible cooling of the medium, electrical heaters are also used in some cases because these are inexpensively and flexibly installable. Such temperature control devices are positioned either directly on the outside of the wall of the pipeline, duct or vessel or within the pipeline, duct or vessel. When temperature control media are used, it is also customary to provide a jacket that forms the outer wall of the pipeline, duct or vessel.

Very particular demands exist when both to high a temperature and too low a temperature of the medium have to be avoided, in particular when these are safety-relevant conditions. Especially when the temperature of thermally sensitive fluids is to be controlled, specifically in the case of electrical heating, there is the risk of local overheating, which is fundamentally an intrinsic problem with these electrical heating devices, since these always release energy with the same heat output per unit length over the entire length or in sections of each heat conductor, but the thermal contact of this heating with the medium-conducting pipe or duct always has a certain degree of nonuniformity in real industrial execution, and, furthermore, temperature measurement points that are used to control or limit the temperature can be used only at particular sites, which means that there is a risk that local overheating can occur comparatively easily without being recognized and eliminated by control measures.

The use of temperature control media that can be universally and reliably safeguarded against both excessively high and excessively low temperature by known technical means has the disadvantage in turn that, with increasing flow distance (connecting pipelines, for example in chemical production plants and especially for the connection of the production plants to their tank farms or port tank farms, or connection pipelines within these tank farms themselves or in port tank farms in which chemicals are intermediately stored in relatively large volumes, can easily have a length of several hundred meters or even kilometers), the temperature of the temperature control medium will decrease in the case of heating of the fluid, or the temperature of the temperature control medium will increase in the case of cooling, depending on the environmental conditions, which can vary considerably both seasonally and even diurnally, such that, especially in long pipelines or ducts, sufficient supply of heat or removal of heat over the entire length of the pipeline or duct can be reliably assured only with difficulty and only with a very high level of technical and hence also (possibly uneconomic) expenditure, if at all.

According to prior art, therefore, additional organizational complexity is regularly required, for example for regular and frequent checks with documentation thereof, in order to achieve appropriately well-functioning and safe operation with such trace heating.

A significant constraint that has to be noted is that not only the regular operating conditions at normal flow on the product side (if, as a result of the considerable heat content flow of the product medium, the influence of external conditions on the temperature thereof is very limited and therefore low) are considered, but also operating conditions that are fundamentally regular and not uncommon, if not likewise regular occurrences, and are the more demanding conditions for the purposes of heat supply and heat removal, and under which the product medium conduits remain filled. These are, for example, a significant reduction or stoppage of through-flow, with the result of stagnant flow of the product medium or stoppage thereof, which is a frequent occurrence even in the case of normal stoppage of delivery pumps, for example, at the end of a transfer operation, or automated closure or switching of pipeline valves, which can also occur as a result of mechanical or electrical faults in the system and the periphery of the pipeline.

It is therefore an object of the present invention to provide an apparatus and a method for controlling the temperature of fluids, which to enable, at proportionate cost, uniform control of the temperature of a medium of which the temperature is to be controlled without local overheating and simultaneously also in long pipelines or ducts, sufficient supply of heat or removal of heat for compliance with a desired and admissible temperature window, and the avoidance and prevention of unwanted or impermissible heat input or heat removal from the environment, taking account of local environmental conditions and the operating conditions throughout the entire length of the pipeline or duct, advantageously also taking account of the range of different climatic zones.

The object is achieved by an apparatus for controlling the temperature of fluids, comprising a wall, a first insulation layer, means of temperature control, and a second insulation layer, where the wall is in contact on one side with the fluid of which the temperature is to be controlled and the first insulation layer has been applied to the side of the wall facing away from the fluid, and the means of temperature control are disposed between the first and second insulation layers.

The object is additionally achieved by a method of controlling the temperature of a fluid in a pipeline, a duct of any cross section or a vessel with an apparatus wherein the means of temperature control are actuated such that a heating output is applied only when the ambient temperature is lower than a minimum permissible temperature of the fluid and/or a cooling output is applied only when the ambient temperature is higher than the maximum permissible temperature of the fluid.

The term “temperature control” in the context of the present invention encompasses not just the heating or cooling of the fluid, but especially also the maintaining of the temperature of the fluid in that heat is prevented from being released from the fluid to the environment, the effect of which can be that the fluid can freeze or that, especially at high outside temperatures and under high insolation, the fluid is heated up to an impermissible temperature. The latter can lead to a loss of efficacy of inhibitors as a result of elevated reactive consumption thereof, and the former can mean a loss of efficacy of the inhibitors, for example as a result of crystallization thereof because of falling solubility of the inhibitor in at least a portion of the fluid, or an uncontrolled reaction, especially polymerization, can be promoted or the fluid can be decomposed.

The disposing of the means of temperature control between the first insulation layer and the second insulation layer, especially in the case of use of electrical heating, ensures that no local overheating can occur, since the first insulation layer means that the heat is not transferred directly from the electrical heater through the generally efficiently heat-conducting wall of the pipeline, duct or vessel to the fluid.

The disposing of the means of temperature control between the first insulation layer and the second insulation layer also has the effect that a smaller portion of the heat released or absorbed by the medium for temperature control is used for controlling the temperature of the fluid than in the case of disposing of the means of temperature control between the wall and just one insulation layer. This likewise prevents possible local overheating or subcooling of the fluid. In particular, it is thus possible to avoid heating of the fluid internally at ambient temperatures below or well below the desired and permissible fluid temperature.

In order to simplify the mounting of the means of temperature control and in order to obtain more uniform distribution of the heat supplied or removed over the circumference of the pipeline or of the duct, it is further preferable when an intermediate layer of a metal having a thickness within a range from 0.2 to 1 mm, especially having a thickness within a range from 0.3 to 0.6 mm, is accommodated between the first insulation layer and the second insulation layer. The metal from which the intermediate layer is manufactured is more preferably aluminum or copper, especially aluminum. In order to be able to mount the intermediate layer in a simple manner, it is also advantageous when it has in two half shells mounted around the first insulation layer.

The fluid of which the temperature is to be controlled may be any free-flowing fluid, for example a fluidized solid, especially fluidized powder or granules, a liquid or a gas, or any mixture thereof. The fluid of which the temperature is to be controlled is more preferably a liquid and especially liquid acrylic acid or methacrylic acid. In general, the liquid acrylic acid or methacrylic acid comprises an inhibitor in order to prevent polymerization. Inhibitors used are, for example, dissolved oxygen, dissolved oxygen together with hydroquinone monomethyl ether, or dissolved phenothiazine. When the inhibitor used is hydroquinone monomethyl ether, it is preferably used with a concentration within a range from 10 to 300 ppm. If the acrylic acid or methacrylic acid is not stored for a prolonged period, but rather, for example, sent directly from production to further processing through a suitable pipeline and is at most intermediately buffered, it is sufficient when the hydroquinone monomethyl ether is used with a concentration within a range from 30 to 80 ppm. This enables direct further processing without first removing the inhibitor from the acrylic acid or methacrylic acid by suitable methods known to the person skilled in the art. If, however, the intention is to store the acrylic acid or methacrylic acid for a prolonged period, for example in order to sell or to ship it, for example for transport by ship, railway or truck, the proportion of hydroquinone monomethyl ether is preferably within a range from 150 to 250 ppm, for example 200 ppm. Phenothiazine as inhibitor is typically used with a concentration within a range from 5 to 300 ppm, generally up to a maximum of 100 ppm.

The minimum permissible temperature of the fluid is, for example, the solidification temperature. Cooling of the fluid below the minimum permissible temperature would then have the effect that the fluid solidifies and hence blocks a pipeline or duct, for example. If the fluid is present in a vessel, solidification even of a portion of the fluid has the effect that this can block an outlet from the vessel, such that the fluid can no longer be withdrawn, or else that the solidified portion remains in the vessel and hence is no longer obtainable. The maximum permissible temperature is, for example, the breakdown temperature of the fluid or, if the fluid has a tendency to polymerize at particular temperatures. Especially in the case of a multitude of ethylenically unsaturated substances, which include (meth)acrylic monomers, but also, for example, in the case of styrene and vinylformamide, there are known and defined temperature thresholds that must not be exceeded in order to effectively prevent reduction in the level of and/or loss of efficacy of inhibitors present (such as hydroquinone monomethyl ether and oxygen dissolved in the fluid) or even the direct onset of chemical reaction (generally free-radical polymerization).

A chemical reaction, whether oligomer formation, polymerization or even breakdown of the fluid, is to be or must generally be prevented, since this can lead to uncontrolled heat input with possible gas formation, increased pressure, possible leakage or bursting of the pipeline or the duct, it is necessary to keep the temperature below defined thresholds, in the case of which it may be advisable to provide for a safety margin for control of the heating output or cooling output both in the case of the minimum permissible temperature and in the case of the maximum permissible temperature. Thus, the minimum admissible temperature is preferably a temperature of 0 to 5 K above the solidification temperature, and the maximum permissible temperature is a temperature 0.5 to 5 K below the breakdown temperature or the polymerization initiation temperature. The polymerization initiation temperature refers here to the temperature at which at least one component of the fluid begins to polymerize, and the polymerization initiation temperature may also be dependent on whether an inhibitor is present. If the first component of the fluid begins to polymerize only at a higher temperature when an inhibitor is used compared to no use of the inhibitor, in the context of the present invention, the polymerization initiation temperature is understood to mean not the temperature at which the component fundamentally begins to polymerize but the temperature at which the component begins to polymerize in spite of the use of the inhibitor. This is generally higher than without the use of the inhibitor.

The wall which is in contact with the fluid of which the temperature is to be controlled and on which the insulation layer has been applied on the side remote from the fluid is preferably a wall of a pipeline through which the fluid flows or of a duct of any cross-sectional shape through which the fluid flows or a wall of a vessel containing the fluid. More preferably, the apparatus is used to control the temperature of fluids in a pipeline or duct of any cross-sectional shape, and so the wall is especially a wall of a pipeline or duct of any cross-sectional shape.

In the context of the present invention, a pipeline is understood to mean a fluid-conducting pipeline having around cross section, where the pipeline may be rigid or flexible. A duct of any cross-sectional shape may be any fully closed duct. The cross-sectional shape of the duct may have any desired shape, for example the shape of a polygon having at least 3 vertices, for example the shape of a triangle, rectangle or square, the shape of a pentagon, hexagon or octagon, or else the shape of an oval, or with at least one curved wall and at least one flat wall or else with at least two curved walls that can have different radii or else have the same radius and an angle at the site of connection of the walls. Most preferably, the wall is the wall of a pipeline or duct having an oval or quadrangular cross section.

In order to prevent overheating or subcooling of the fluid, it is preferable when the means of temperature control can be operated with a defined heating output or cooling output. This permits supply or removal of such an amount of heat that the temperature of the fluid can be kept within a defined range. In order to control the heating output or cooling output, it is also advantageous when the temperature of the fluid is measured at least at the exit from the apparatus which is heated or cooled. More exact control of the heat to be supplied or removed is possible when the temperature is measured at multiple sites and heat is supplied or removed depending on the temperature of the fluid.

In order to supply or remove the heat, the means of temperature control may be configured such that the temperature of only a section of the wall in each case can be controlled by the means of temperature control. This permits supply or removal of the heat necessary specifically in the corresponding sections. In this case, it is also necessary for the control of heat supply and/or heat removal to detect the temperature at the inlet and at the outlet in a section and, using the temperatures, to feed in or remove the necessary amount of heat for heating or cooling.

Depending on whether the temperature is not to exceed a maximum permissible temperature or go below a minimum permissible temperature, the means of temperature control comprise a cooling device with which the fluid can be cooled or a heater with which the fluid can be heated. If the temperature is neither to go below a minimum temperature nor to exceed a maximum temperature, the means of temperature control preferably comprise both a heater and a cooling device.

The heater used may be any heater known to those skilled in the art, for example a heater with a heat conduit through which a heating medium flows or an electrical heater. Correspondingly, it is also possible to use any cooling device known to the person skilled in the art, such as a cooler by means of a cooling conduit through which a cooling medium flows or else an electrical cooler, for example with Peltier elements. In the case of temperature control with a heating medium or a cooling medium, it is preferable when the heating medium or cooling medium can be fed in with a defined temperature. The adjustment of the heating output or cooling output can then be adjusted by the flow rate of the heating medium or cooling medium. An increase in the flow rate has the effect that more heat can be supplied or, correspondingly in the case of cooling, more heat can be removed.

Correspondingly, a decrease in the flow rate leads to a reduction in the heat supplied or heat removed. Variation of the flow rate permits faster reaction to changes in the ambient conditions or in the temperature of the fluid flowing through the pipeline or duct than a change in the feed temperature of the heating medium or cooling medium.

Since, in the case of temperature control with a heating or cooling medium, for example steam, oil or any other liquid heating medium or a liquid coolant, it is not possible for temperatures higher than the temperature of the heating medium or lower than the temperature of the cooling medium to occur even at local hotspots in the connection of heating conduits or cooling conduits through which the heating medium or cooling medium flows with the wall, the apparatus of the invention is especially suitable for controlling the temperature of a fluid with means of temperature control that include electrical heating. The advantage of such electrical heating is that it is possible to supply a defined heating output, where the heating output is typically or generally equal over the entire length of the electrical heating per unit length. A further advantage of electrical heating is that the heating output is constant over the entire area of which the temperature is to be controlled, whereas, in the case of a liquid or gaseous temperature control medium, the temperature decreases over the flow length of the temperature control medium when heating is effected with the temperature control medium, or increases when cooling is effected with the temperature control medium. The effect of this is that the greatest amount of heat can be transferred at the position where the temperature control medium can first transfer heat to the fluid of which the temperature is to be controlled or can absorb heat from the fluid of which the temperature is to be controlled. Especially in the case of very long pipelines or ducts, this can have the effect that the heat to be transferred by the temperature control medium is insufficient over the entire length of the pipeline or docked to prevent the temperature from exceeding a maximum temperature or going below a minimum temperature depending on the ambient temperature. This shortcoming can quite possibly be alleviated to a certain degree in that substreams of the medium are guided separately in flow direction and fed in at positions further downstream, but this brings about a stepped characteristic with limited improvement.

Especially for thermally sensitive fluids, it is therefore particularly preferable when the means of temperature control include electrical heating. If cooling of the fluid is required, it is additionally advantageous also to provide for electrical cooling, for example with Peltier elements, rather than a liquid or gaseous cooling medium. When an electrical heater in the form of heat conductors is used, it is further preferable when an even number of heat conductors is provided. This has the advantage that the electrical connections of the heat conductors can be made at one end, such that this simplifies the installation and especially the electrical connection of the heat conductors. In order to enable electrical connection at one end, two heat conductors in each case, which can be operated with direct current or alternating current, are electrically connected to one another at the opposite end from the electrical connection.

Especially when the temperature of the fluid generally has to be controlled by heating and there is cooling only in exceptional cases, for example on very hot summer days, it is also possible, for example, to provide an electrical heater and a cooling conduit through which a cooling medium flows, and to pass the cooling medium through it only when cooling is required. It will be appreciated that it is alternatively also possible to provide both electrical heating and electrical cooling when the means of temperature control are to include both cooling and heating.

If the apparatus for temperature control is being used for a fluid that cannot be overheated, or the maximum permissible temperature of the fluid is above the customary maximum ambient temperature, it is unnecessary to provide for additional cooling. In this case, the means of temperature control include solely means of heating and especially an electrical heater.

However, it is also possible in accordance with the invention for a relevant number of cases of application to fluids that must not be overheated—specific examples here include acrylic acid and methacrylic acid—to achieve sustained advantageous and reliable compliance as desired with the permissible temperature window of the medium by means of an inventive configuration and dimensioning of insulation and electrical heating without any cooling apparatus.

Especially when the wall is a wall of a duct or pipeline, it is preferable when the electrical heater comprises at least one heat conductor that runs parallel to the flow direction of the fluid in the duct or pipeline or around which the duct or pipeline is wound. The number of heat conductors is also dependent on the heat output to be supplied. Especially when a large heat output has to be supplied in order to maintain the desired temperature of the fluid, it is advantageous when two or more parallel heat conductors are used since, in this case, the total heat output is distributed between the individual heat conductors. This also has the effect that, for the same heat output, as the number of heat conductors increases, the individual heat conductors can be at a lower temperature and hence can be sized for a lower specific heat output.

Especially in the case of heat conductors that run parallel to flow direction, the transfer of the greatest amount of heat takes place over the shortest distance between heat conductor and wall. The effect of this can be that the fluid is not heated uniformly in the pipeline. For uniform control of the fluid temperature in the pipeline or duct, it is therefore preferable, especially in the case of use of only a few heat conductors, for example in the case of use of three or fewer heat conductors, and especially in the case of use of just one heat conductor, when the heat conductor(s) is/are wound around the pipeline or duct. In this case, heat is supplied uniformly to the pipeline or duct from all sides. Alternatively, uniform temperature control can also be achieved by use of the intermediate layer composed of a material of good thermal conductivity, especially of aluminum or copper.

More preferably, the heat output supplied by the electrical heating can be adjusted such that the means of temperature control have the same temperature as the fluid of which the temperature is to be controlled. In this way, the temperature of the fluid that is to be controlled is kept constant, and there is no cooling or heating, such that local overheating or subcooling can also be prevented. In order to be able to operate the means of temperature control in such a way that the temperature of the means of temperature control is the same as that of the fluid of which the temperature is to be controlled, it is also particularly advantageous when the temperature of the means of temperature control is measured. Especially when the means of temperature control encompass a large area or the temperature of a long pipeline or duct is to be controlled, it is also advantageous when the temperature of the means of temperature control is detected at multiple sites.

In addition, environmental temperature conditions of relevance for the temperature control, for example a representative local temperature that also takes into account the removal of heat via radiation especially in the case of clear weather and ‘sight’ of the medium conduit in the direction of space, especially at night, but also direct insolation during the day, are included in the design. This is material especially when there is high insolation with simultaneously high ambient temperature during the day and significant cooling at night.

Means of detecting of the temperature of the fluid and the temperature of the means of temperature control may be any of the means of detecting temperature that are known to the person skilled in the art. Suitable means of detecting the temperature are, for example, thermometers or temperature sensors, for example resistance temperature sensors such as thermocouples or temperature sensors based on nickel or platinum, for example PT100 temperature sensors, or infrared temperature sensors.

Material used for the first insulation layer and the second insulation layer may be any material suitable for insulation. The material used for the first insulation layer and the second insulation layer is preferably foam glass or fiber materials such as mineral fibers, glass fibers, ceramic fibers, for example in the form of mineral wool. Preference is given to using insulation materials which are suitable and approved in relation to chemical compatibility, but also porosity, in order to achieve minimization of risks in the event of fluid leaks, and which do not constitute a fire load and additionally prevent penetration of moisture from the outside. More preferably, therefore, foam glass is used for the first insulation layer. It is possible that the materials used for the first insulation layer and the second insulation layer are different materials or the same material. It is preferable here to use the same material, especially foam glass, for the first insulation layer and the second insulation layer, which prevents reduction in the total insulation quality in the case of unwanted lack of imperviosity of the outer shell through ingress of water, for example through rain or condensation of air humidity. It is likewise preferable to make the first insulation layer from foam glass and the second insulation layer from mineral wool, which offers cost benefits, but nevertheless offers the certain effect of prevention of impermissible heating of the product fluid by the electrical heating with simultaneous prevention of impermissible cooling via low outside temperature. A certain disadvantage could be possibly reduced heating protection in the case of a wet second insulation layer in the event of high ambient temperatures and without a cooling device, but this could be contained by occasional inspections.

According to the invention, the choice of layer thicknesses of the first and second insulation layers is not to be guided primarily by the customary criteria in the prior art of an ‘economic’ layer thickness, but rather mainly by the product-specific demands. The layer thickness of the first insulation layer and of the second insulation layer may the same or different. In a preferred variant, the first insulation layer and the second insulation layer have the same layer thickness, since, purely as a result of the geometry, the outer surface area of the second insulation layer based on length is much greater than that of the first insulation layer, and hence the heat output released by the electrical heating is preferably released to the outside, i.e. where the cooling environment is, such that the possibility of overheating of the product fluid even in the case of a low flow rate is virtually ruled out. In addition, the total thickness of the insulation is thus kept small, which is advantageous for the laying of pipelines and the space demand.

Illustrative model calculations for the pipeline diameters of technical relevance in such applications with nominal widths of 50 mm=2 inches, 80 mm=3 inches, 100 mm=4 inches and 150 mm=6 inches have shown that it is particularly preferable to give the first insulation layer a thickness of 20 to 40 mm, more preferably 25 to 35 mm, for example 30 mm, since, irrespective of the thickness of the external insulation, virtually no relevant heating of the product fluid can occur in relevant periods of time (typically 24 hours, since any longer flow stoppage is either in the event of a fault that has to be checked or eliminated, or the pipeline has to be emptied in the case of a planned action). In the case of electrical heating with outside insulation only that has been applied directly to the pipe according to prior art, impermissible heating of the product medium will regularly occur within the 24 hours in question.

The heat flow which is transferred by the first insulation layer in the direction of the fluid and the heat flow which is transferred by the second insulation layer in the direction of the environment is dependent on the material and the thickness of the respective insulation layer and additionally also on the difference in temperature between the means of temperature control and the fluid or medium for temperature control and the environment. The thickness or else the material of the first insulation layer and the second insulation layer may be chosen depending on the heat flow to be transferred to the fluid or to the environment. If a maximum heat flow is to be transferred to the fluid, it is advantageous to make the first insulation layer with a lower layer thickness than the second insulation layer and/or to choose a material for the first insulation layer that has better thermal conductivity than the material of the second insulation layer. Correspondingly, it is advantageous, if just a low heat flow is to be transferred to the fluid, to execute the first insulation layer in a greater layer thickness than the second insulation layer and/or to choose a material for the second insulation layer that has better thermal conductivity than the material of the first insulation layer.

It is particularly preferable, however, when the first insulation layer and the second insulation layer have the same heat resistance. This means that the thermal conductivity and layer thickness of the first and second insulation layers are the same. This is achieved especially in that the material of the first insulation layer and of the second insulation layer is the same. Especially in the case of pipelines, because of the increasing surface area of the rotationally symmetric, cylindrical geometry in the outward direction for heat transfer, outward heat flow is always noticeably preferred over inward heat flow, especially for the most relevant (nominal) pipeline diameters of 50 mm=2 inches to 100 mm=4 inches.

In order to protect the second insulation layer and to prevent the second insulation layer from being damaged, especially by weathering influences, or penetrated by (rain)water, it is possible and advisable to apply a cover to the second insulation layer. Such a cover is, for example, a shell made from a metal, especially of zinc-plated or painted sheet metal or aluminum, or else made from stainless steel. The selection of material typically follows the known recommendations and provisions for the respective product medium, but especially the given requirements of plant safety for installation.

Illustrative embodiments of the invention are shown in the figures and are elucidated in detail in the description that follows.

The figures show:

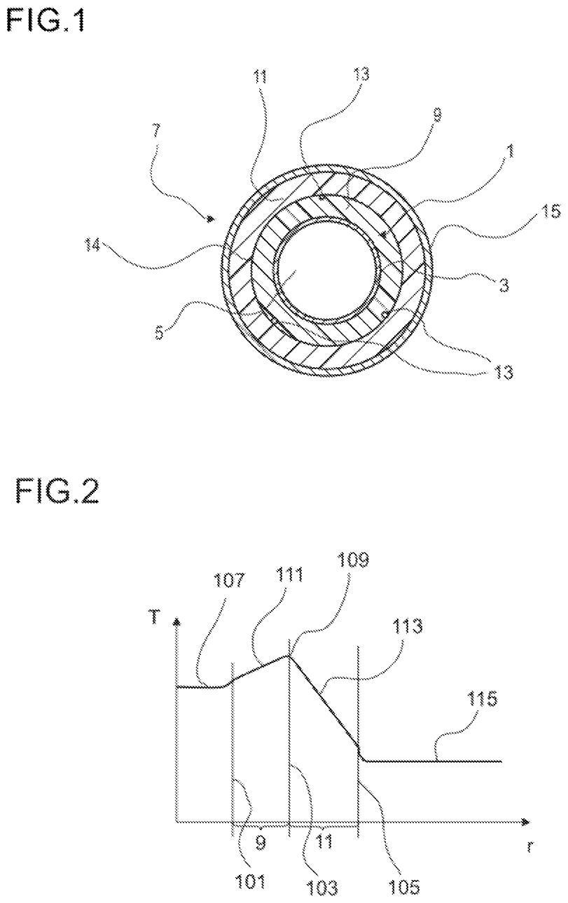

FIG. 1 a cross section through a pipeline having the apparatus of the invention for controlling the temperature of fluids;

FIG. 2 a temperature profile through the apparatus for controlling the temperature of fluids with an ambient temperature below the temperature of the fluid;

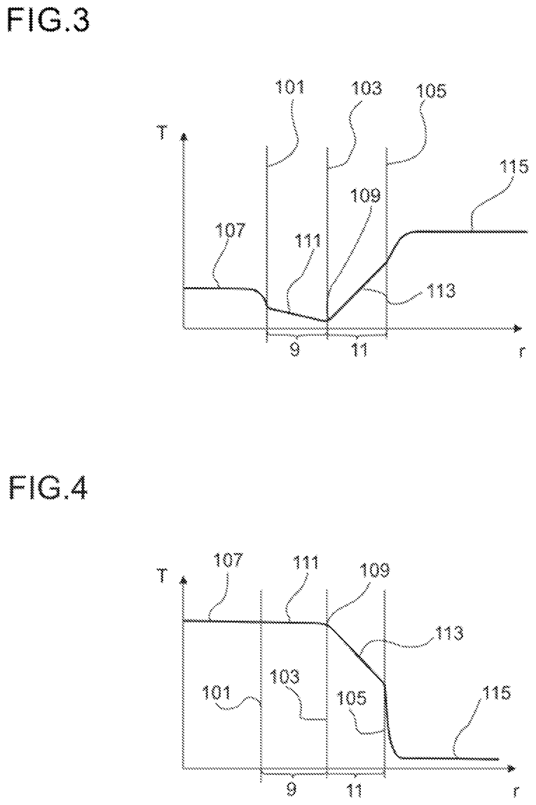

FIG. 3 a temperature profile through the apparatus for controlling the temperature of fluids with an ambient temperature above the temperature of the fluid;

FIG. 4e a temperature profile through the apparatus for controlling the temperature of fluids with an ambient temperature below the temperature of the fluid, where the heating output is controlled such that the means of temperature control are at the same temperature as the fluid.

FIG. 1 shows a cross section through a pipeline having an apparatus of the invention for controlling the temperature of fluids.

A pipeline 1 comprises a wall 3 that encloses an interior 5 through which a fluid can flow. The wall 3 is simultaneously the wall of the apparatus for controlling the temperature of fluids 7, which is in contact with the fluid on one side, and a first insulation layer 9 has been applied on the side remote from the fluid. The first insulation layer 9 is surrounded by a second insulation layer 11.

According to the invention, means of temperature control 13 are disposed between the first insulation layer 9 and the second insulation layer 11. There is preferably additionally an intermediate layer 14 that serves for better heat flow distribution and temperature homogenization at the periphery between the first insulation layer 9 and the second insulation layer 11, where the intermediate layer 14 is preferably a thin metallic layer on which the means of temperature control are secured. The intermediate layer 14 is made, for example, from aluminum with a thickness of 0.2 to 1 mm, preferably 0.3 to 0.5 mm, and in two shells/halves for advantageous assembly. The means of temperature control 13 may, as shown here, be electrical heaters. In this case, the means of temperature control 13 serve for heating, and it is possible to supply heat to a fluid that flows through the pipeline 1. Because of the positioning of the means of temperature control 13, in this case, heat is also simultaneously transferred outward to the environment, or quite possibly preferentially or even almost exclusively, which prevents local overheating from occurring at the wall 3 of the pipeline, and also prevents the product medium from being heated significantly or even overheated.

As well as the electrical heat conductors shown here, the means of temperature control 13 may also be pipelines or ducts of any cross section through which a heating medium or cooling medium flows, or else heating elements or cooling elements of any other shape, for example in the form of two-dimensional elements applied to the first insulation layer 9. When the heating elements or cooling elements are of any desired shape, electrical heating elements or cooling elements in particular are used.

When electrical heat conductors or pipelines or ducts are used as means of temperature control 13, these may run parallel to the central axis of the pipeline 1 or run around the pipeline 1, for example in the form of a spiral. It is also possible that the means of temperature control 13 are applied in a meandering manner to the first insulation layer 9. This is possible especially in the case of use of electrical heat conductors, since these release a constant heat output over the entire length. A typical and preferred arrangement for reasons of accessibility for assembly operations is a linear arrangement parallel to the central axis of the pipeline, where the heat conductor in the case of use of just one heat conductor is preferably disposed somewhat offset from the middle on the underside (in the 5 to 6 or 6 to 7 o'clock position), and the heat conductors in the case of use of two heat conductors are preferably disposed at at the 7 to 8 o'clock and 4 to 5 o'clock positions, in the case of use of three heat conductors preferably at the 8 o'clock, 12 o'clock and 4 o'clock positions, and in the case of four heat conductors preferably at the 7 to 8 o'clock, 10 to 11 o'clock, 1 to 2 o'clock and 4 to 5 o'clock positions. For an advantageous design of the electrical connection, an even number of heat conductors is particularly preferred, since both ends of the electrical connection of a linear single-court heat conductor can be positioned locally at a common connection site.

In order to protect the material of the second insulation layer 11 and especially in order to prevent aging or damage to the material of the second insulation layer 11 by weathering influences or other environmental influences, it is particularly preferable when the second insulation layer is surrounded by a shell 15. The shell 15 is preferably manufactured from a metal, for example stainless steel, aluminum, zinc or zinc-plated or painted steel or aluminum. As an alternative to the use of a metal for the shell 15, it is also possible to manufacture the shell 15 from a polymer material. However, preference is given to the use of a metal.

The temperature profile that results from the apparatus for controlling the temperature of fluids, for example through the pipeline shown in cross section in FIG. 1, is shown for three different variants in FIGS. 2 to 4.

FIGS. 2 to 4 each show the progression through the apparatus r from the interior of the apparatus to the environment on the abscissa, and the temperature T on the ordinate. In all three figures, the position of the inside of the first insulation layer 9 is shown by a vertical line 101, a second vertical line 103 denotes the position at which the second insulation layer 11 adjoins the first insulation layer 9, and a third vertical line 105 the outside of the second insulation layer 11. The wall 3 of the pipeline or of a vessel and of the shell 15 is not included in FIGS. 2 to 4 since, because of the low thickness of the wall 3 and of the shell 15 and of the material of good thermal conductivity that is typically used, the temperature difference between the inside and the outside of the wall 3 or of the shell 15 is generally negligibly small compared to the temperature differences that form through the insulation layers 9, 11. In addition, because of the small effects by comparison with thermal conduction and convection, the influence of thermal radiation has not been taken into account. The temperature gradients that can be read off from the plots of temperature may be assigned equivalently corresponding heat flows or resistances of heat transfer.

FIG. 2 shows a temperature profile through the apparatus for controlling the temperature of fluids with an ambient temperature below the temperature of the fluid.

Especially in the case of a well-mixed fluid or a pipeline with turbulent flow, the fluid within the apparatus for controlling the temperature of a fluid has an essentially constant fluid temperature 107.

Because of heat conduction and convection, the temperature at the wall 3 of the pipeline or of the vessel increases when, as shown in FIG. 2, the temperature 109 of the means of temperature control 13 is higher than the fluid temperature 107. Because of the conduction of heat to the first insulation layer 9, the temperature decreases from the outside inward, i.e. from the means of controlling the temperature in the direction of the wall 3 of the pipeline or of the vessel, so as to result in the temperature profile 111 rising in a linear manner, shown in FIG. 2, from the fluid in the direction of the means of temperature control 13 in the first insulation layer 9. Since there is also heat transfer through the second insulation layer 11, the temperature here decreases from the means of temperature control 13 outward in accordance with the temperature profile 113 shown. On the outside of the second insulation layer 11 or of the shell 15 (not shown here), the temperature decreases further because of heat conduction effects and convection until the ambient temperature 115 is attained at a certain distance from the second insulation layer 11 or the shell 15.

By contrast with the temperature profile shown in FIG. 2, FIG. 3 shows a temperature profile that results when the fluid temperature 107 is below the ambient temperature 115, and the means of temperature control 13 provided is a cooling device. In order that the means of temperature control 13 are able to cool, it is necessary that the temperature 109 of the means of temperature control 13 is below the fluid temperature 107. Because of the low temperature 109 of the means of temperature control 13, the temperature of the fluid close to the wall decreases because of heat conduction effects and convection, and a linear temperature progression 111 arises in the first insulation layer 9, with a temperature decreasing from the interior of the apparatus for temperature control in the direction of the means of temperature control 13. Because of the higher ambient temperature 115 outside the apparatus for the temperature control, the temperature in the second insulation layer increases from the inside outward toward the environment with a linear temperature progression 113. At the outer wall, there is again a nonlinear increase in temperature from the temperature of the outer wall to the ambient temperature 115 because of heat conduction and convection in the ambient air.

An ideal temperature progression is shown in FIG. 4. As in FIG. 2 as well, the ambient temperature 115 here is lower than the fluid temperature 107. However, by contrast with the progression shown in FIG. 2, in the progression shown here, the amount of heat which is supplied by the means of temperature control 13 is adjusted such that the temperature 109 of the means of temperature control 13 corresponds to the fluid temperature 107. The equal temperature of the means of temperature control 13 and of the fluid results in a constant temperature of the fluid through the wall 3 and the first insulation layer 9 as far as the means of temperature control 13, which are disposed here too at the position identified by line 103 between the first insulation layer 9 of the second insulation layer 11.

Because of the equal temperature 109 of the means of temperature control 13 and of the fluid, only a small amount is released into the interior of the apparatus for controlling the temperature of the fluid, for example the pipeline or the vessel. A further portion is released externally to the environment, such that the temperature at the outer wall is higher than the ambient temperature 115. The heat is then released to the environment via heat conduction and convection, so as to result in a nonlinear temperature drop here too from the temperature on the outside of the second insulation layer 11 or of the shell 15 to the ambient temperature 115.

In accordance with the temperature progression that lies below the fluid temperature 107 for an ambient temperature 115 here, even when the ambient temperature is above the fluid temperature and the means of temperature control also includes a cooling device, it is particularly advantageous when a sufficient amount of heat can be absorbed by the means of temperature control that the temperature of the means of temperature control is equal to the fluid temperature.

1.-15. (canceled)

16. An apparatus for controlling the temperature of fluids, comprising a wall, a first insulation layer, means of temperature control, and a second insulation layer, where the wall is in contact on one side with the fluid of which the temperature is to be controlled and the first insulation layer has been applied to the side of the wall facing away from the fluid, and the means of temperature control are disposed between the first insulation layer and the second insulation layer.

17. The apparatus according to claim 16, wherein the fluid is a fluidized solid, a liquid, a gas or any mixture thereof.

18. The apparatus according to claim 16, wherein the wall is a wall of a pipeline through which the fluid flows or a duct of any cross-sectional shape through which the fluid flows or a wall of a vessel comprising the fluid.

19. The apparatus according to claim 16, wherein the means of temperature control can be operated with a defined heating output or cooling output.

20. The apparatus according to claim 16, wherein the means of temperature control comprise an electrical heater.

21. The apparatus according to claim 16, wherein an interlayer of a metal having a thickness within a range from 0.2 to 1 mm is accommodated between the first insulation layer and the second insulation layer.

22. The apparatus according to claim 16, wherein the wall is a wall of a duct or of a pipeline and the electrical heater comprises at least one heat conductor which runs parallel to the flow direction of the fluid in the duct or in the pipeline or which is wound around the duct or the pipeline.

23. The apparatus according to claim 16, wherein the means of temperature control comprise a cooling device, where the cooling device comprises at least one cooling conduit through which a cooling medium flows.

24. The apparatus according to claim 16, wherein the first insulation layer and the second insulation layer have the same layer thickness.

25. The apparatus according to claim 16, wherein the first insulation layer has a layer thickness within a range from 20 to 40 mm.

26. The apparatus according to claim 16, wherein the first insulation layer and the second insulation layer have the same heat resistance.

27. A method of controlling the temperature of a fluid in a pipeline, a duct of any cross section or a vessel with an apparatus according to claim 16, wherein the means of temperature control are actuated such that a heating output is applied only when the ambient temperature is lower than a minimum permissible temperature of the fluid and/or a cooling output is applied only when the ambient temperature is higher than the maximum permissible temperature of the fluid.

28. The method according to claim 27, wherein the heating output is adjusted such that the means of temperature control are at the same temperature as the fluid of which the temperature is to be controlled.

29. The method according to claim 27, wherein the maximum permissible temperature is 0.5 to 5 K below the breakdown temperature of a component of the fluid or the polymerization initiation temperature and/or the minimum permissible temperature is 0 to 5 K below the solidification temperature of the fluid.

30. The method according to claim 27, wherein the fluid is methacrylic acid or acrylic acid stabilized by hydroquinone monomethyl ether together with dissolved oxygen or with phenothiazine.
